(19) United States
(12) Patent Application Publication
(10) Pub. No.: US 2021/0201260 A1
(43) Pub. Date: Jul. 1, 2021

(54) System and Method for Transportation Management

(71) Applicant: Ship It Pro LLC, Oakland, TN (US)

(72) Inventor: Wesley Montague, Oakland, TN (US)

(73) Assignee: Ship It Pro LLC, Oakland, TN (US)

(21) Appl. No.: 17/128,783

(22) Filed: Dec. 21, 2020

Related U.S. Application Data
(60) Provisional application No. 62/954,439, filed on Dec. 28, 2019.

(51) Int. Cl. G06Q 10/08

(52) U.S. Cl. CPC G06Q 10/0835; G06Q 10/0832

(57) ABSTRACT

A vehicle load management system is disclosed. The vehicle load management system has a vehicle load management module, comprising computer-executable code stored in non-volatile memory, a processor, and a user device configured to communicate with the vehicle load management module and the processor. The vehicle load management module, the processor, and the user device are configured to receive a vehicle load management request data for a product, identify one or more shipping container parameters of a shipping container based on the vehicle load management request data, select a transportation mode data identifying a transport vehicle based on the one or more shipping container parameters, and determine a securement configuration for the product in the shipping container based on the one or more shipping container parameters and the transportation mode data.

### CROSS-REFERENCE TO RELATED APPLICATIONS

This application claims priority to U.S. provisional patent application 62/954,439 filed on Dec. 28, 2019, and entitled “System and Method for Automated Vehicle Load Management,” the entire disclosure of which is incorporated herein by reference.

### TECHNICAL FIELD

Various embodiments relate generally to transportation management.

### BACKGROUND OF THE DISCLOSURE

Shipping involves load transportation. A load may be a product purchased by a customer or any product that is moved. In some examples, the product may be shipped to the customer by truck or railroad boxcar. In some scenarios, a product may be damaged during transport. In an illustrative example, the operator of a truck or railroad boxcar may be liable for damage to a transported load. A product damaged during shipping may result in a business loss.

Transport operators may utilize adequate packaging and load securement to prevent damage to a load during shipping. Some packaging and load securement configurations may be approved based on industry standards or regulations. Some loads may be secured or protected with dunnage. In an illustrative example, dunnage may include various quantities, types, and configuration of void fill, airbags, strapping, or friction mats useful to secure a load. Some approved load securement configurations may include predetermined dunnage type and quantity specific to a load, container, or transport mode such as a boxcar, truck, airplane, or ocean vessel.

In an illustrative example, an approved load securement configuration may be approved for a specific product type based on testing. A shipper desiring to transport a custom load that is not associated with a preapproved load securement configuration may expend significant resources adjusting product, containers, or dunnage to achieve load securement adequate to protect a load during shipping.

### SUMMARY OF THE DISCLOSURE

In one exemplary aspect, the present disclosure is directed to a vehicle load management system. The vehicle load management system includes a vehicle load management module, comprising computer-executable code stored in non-volatile memory, a processor, and a user device configured to communicate with the vehicle load management module and the processor. The vehicle load management module, the processor, and the user device are configured to receive a vehicle load management request data for a product, identify one or more shipping container parameters of a shipping container based on the vehicle load management request data, select a transportation mode data identifying a transport vehicle based on the one or more shipping container parameters, and determine a securement configuration for the product in the shipping container based on the one or more shipping container parameters and the transportation mode data.

In another exemplary aspect, the present disclosure is directed to method. The method includes receiving a vehicle load management request data for a product from a user device, identifying one or more shipping container parameters of a shipping container based on the vehicle load management request data, selecting a transportation mode data identifying a transport vehicle based on the one or more shipping container parameters, determining a securement configuration for the product in the shipping container based on the one or more shipping container parameters and the transportation mode data, and interactively visualizing the securement configuration for the product in the shipping container in the transport vehicle using the user device.

Apparatus and associated methods relate to selecting shipping container transportation based on container parameters determined as a function of product specifications, determining a product configuration in the container based on the product and the transportation, and interactively visualizing a configured container load arrangement in a transport vehicle. In an illustrative example, the shipping container may be a railroad boxcar. The container parameters may include, for example, size and strength, permitting container configuration adapted to the load. In some embodiments, the product configuration in the container may include a dunnage configuration selected based on container performance data and transport mode. Some embodiments may select load securement configurations approved by transport vehicle operators and regulations to adequately protect the load during shipping. Various examples may advantageously provide visualization of the container load arrangement in a transport vehicle, permitting a product shipper to interactively select a suitable dunnage configuration to protect the load.

Various embodiments may achieve one or more advantages. For example, some embodiments may improve a user's ease of access to effective load securement. This facilitation may be a result of reducing the user's effort selecting an approved load securement configuration and arranging the load containers in the user's preferred transport vehicle. Various embodiments may advantageously improve transportation management profitability based on enhancing load securement visibility and accountability. Some embodiments may automatically reduce a user's exposure to the risk of business losses due to shipping damage claims. Such automatic reduction to the risk of business losses may be a result of automatically selecting load securement and load arrangement configurations preapproved to provide adequate protection during shipment. In some designs, the time and effort involved in approving a new load plan configuration may be reduced. This facilitation may be a result of submitting to insurance or transport administrators a load plan configuration automatically generated by an embodiment vehicle load management system to satisfy shipping regulations and standards, reducing the approval process from as much as two years to a month or less.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an embodiment automated vehicle load management system in an exemplary operational scenario selecting shipping container transportation based on container parameters determined as a function of product specifications, determining a product configuration in the container based on the product and the transportation, and interactively visualizing a configured container load arrangement in a transport vehicle.

FIG. 2 depicts a schematic view of an embodiment automated vehicle load management network.

FIG. 3 depicts a structural view of an exemplary computing device adapted with an embodiment VLME (Vehicle Load Management Engine) configured to automate vehicle load management.

FIG. 4 depicts a process flow of an embodiment VLME (Vehicle Load Management Engine) in an illustrative automatic vehicle load management scenario.

FIGS. 5A-5V together depict illustrative screen capture views of an embodiment mobile app configured to facilitate automatic vehicle load management.

Like reference symbols in the various drawings indicate like elements.

### DETAILED DESCRIPTION OF ILLUSTRATIVE EMBODIMENTS

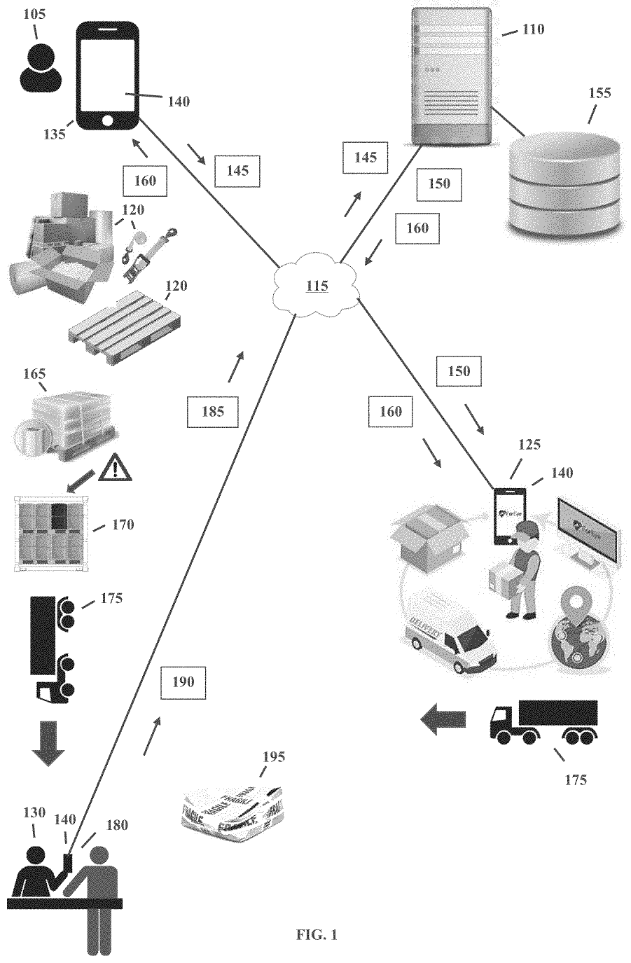

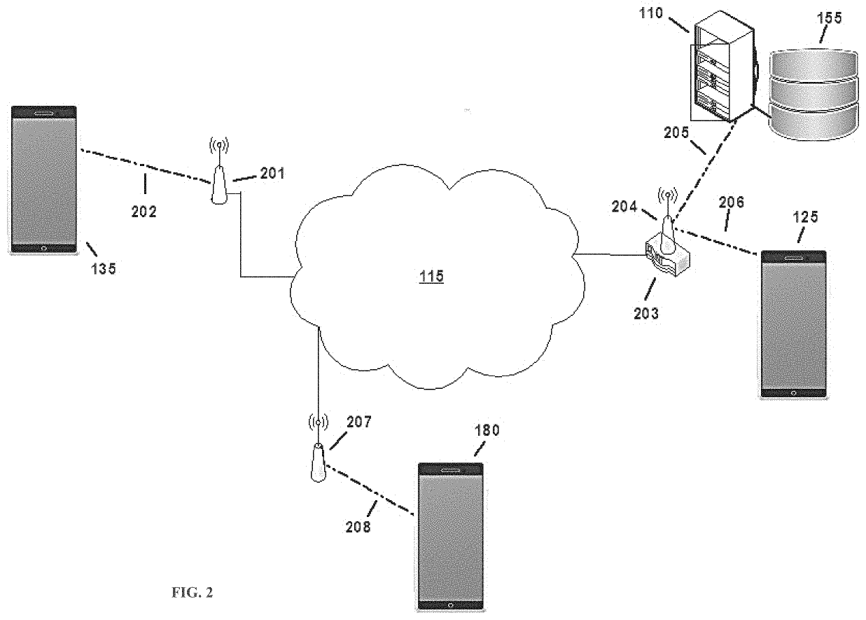

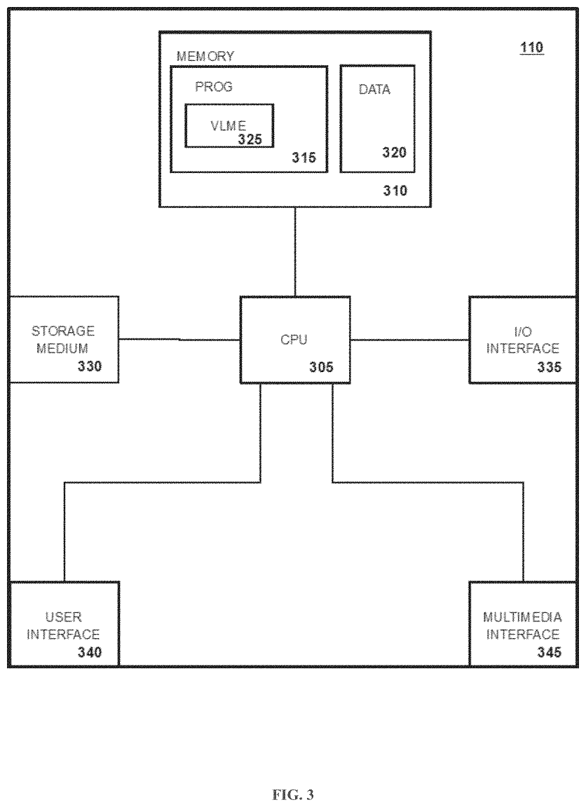

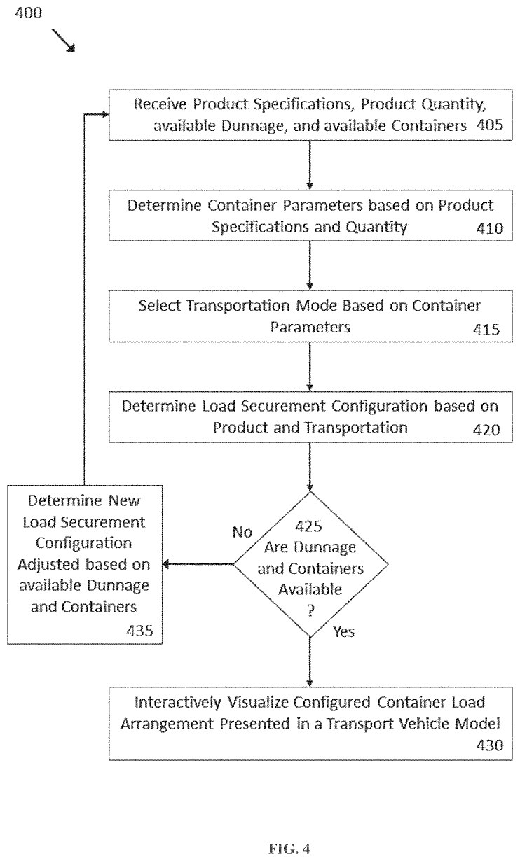

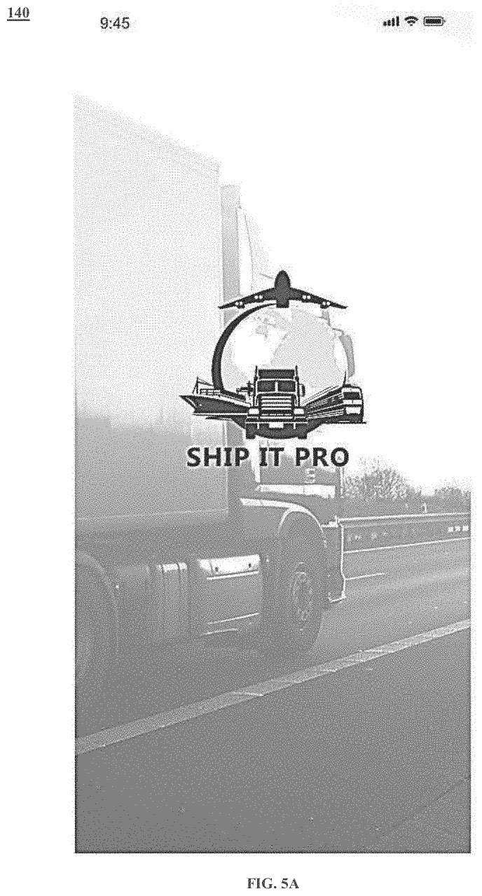

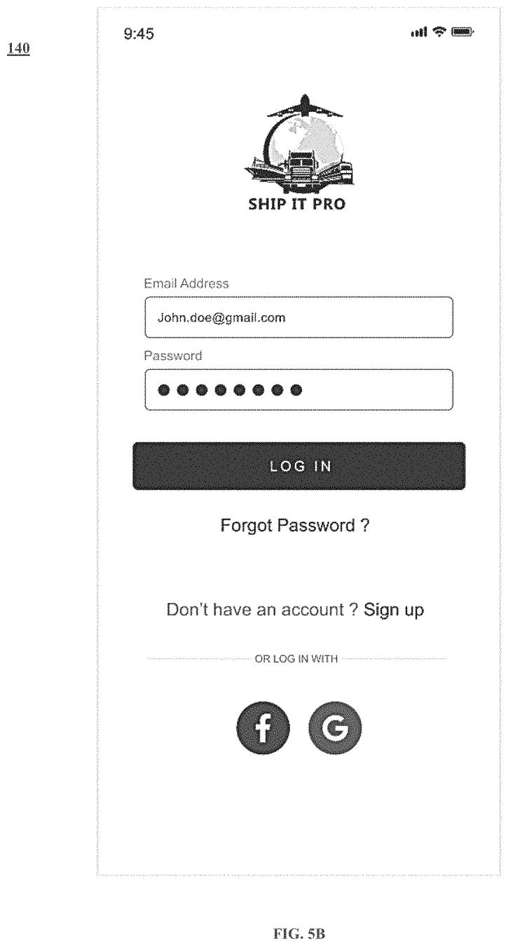

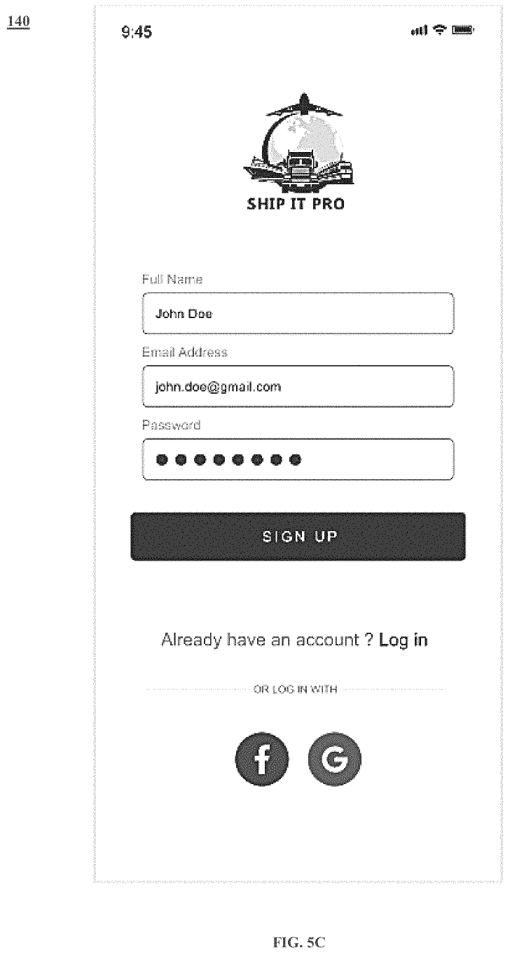

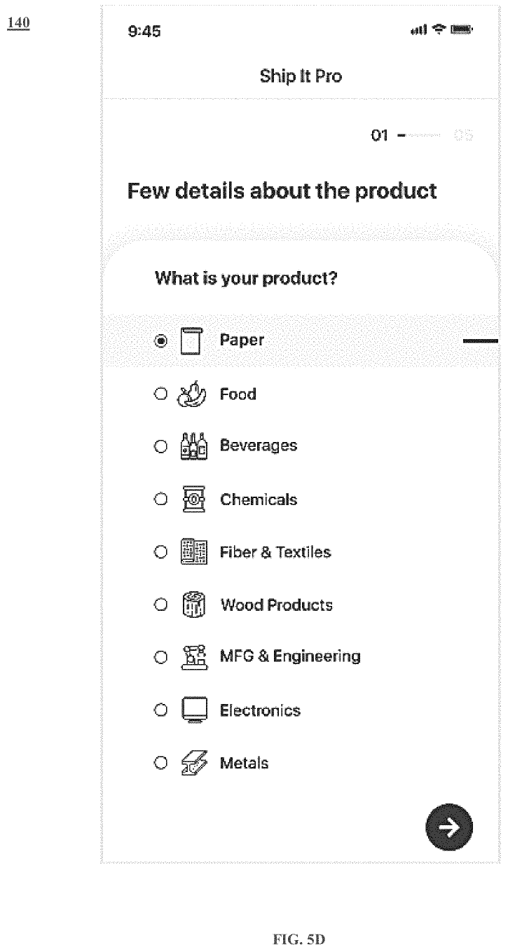

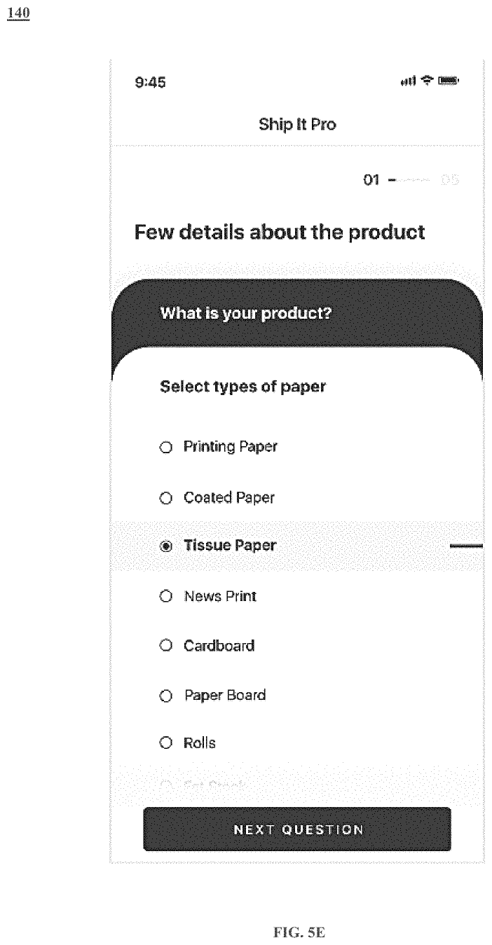

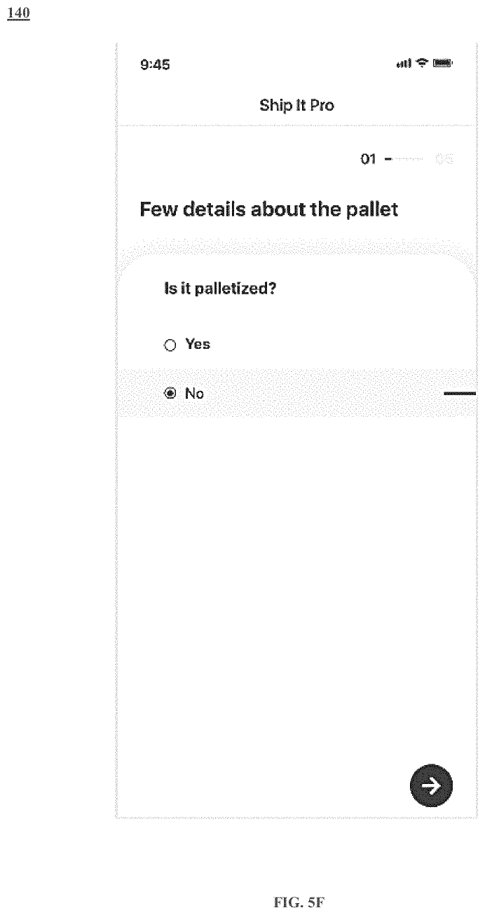

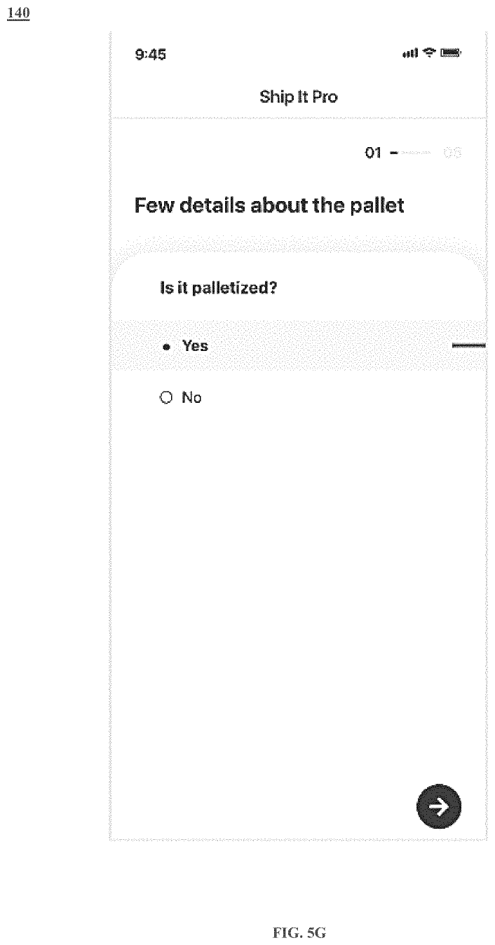

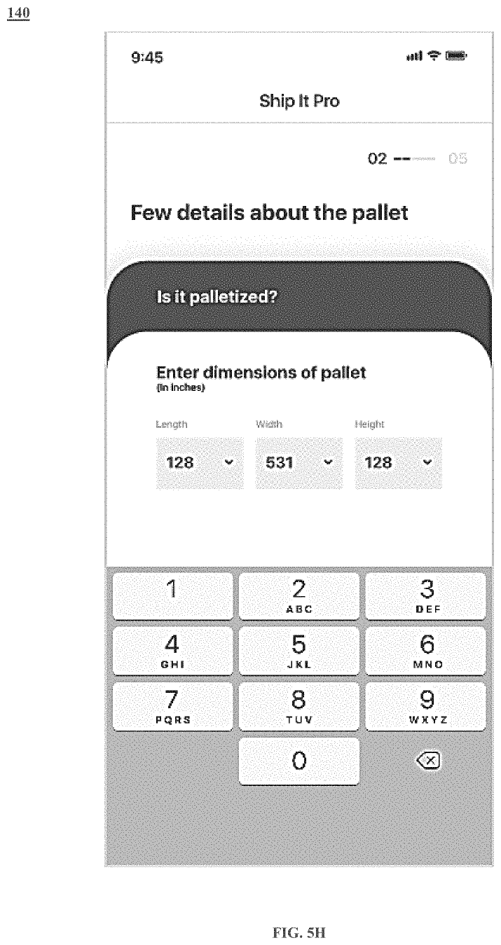

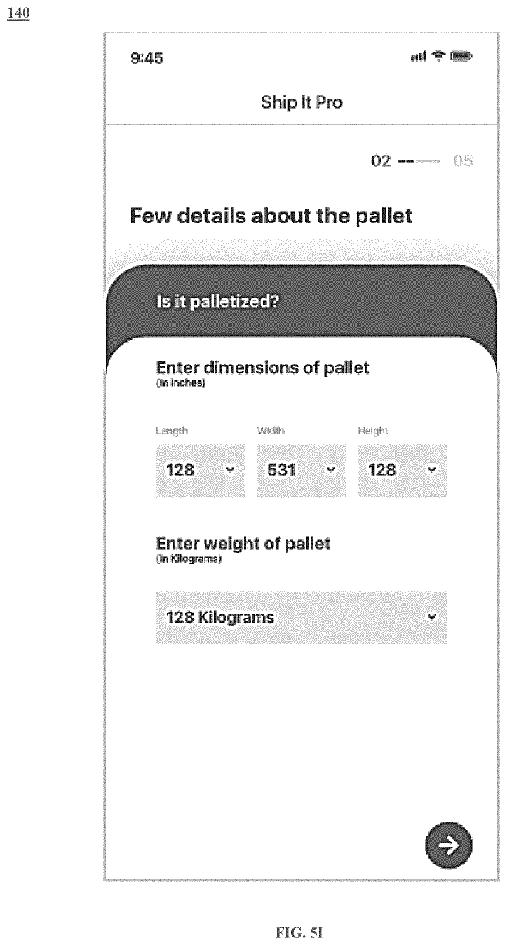

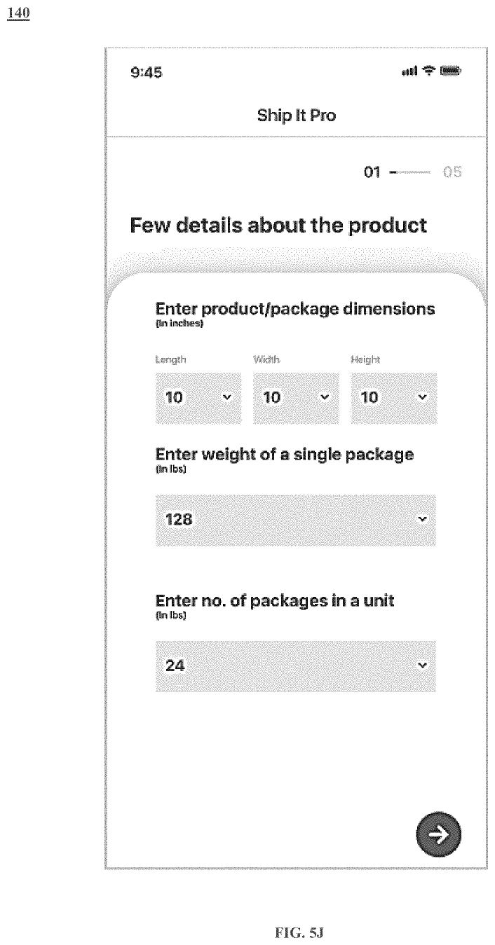

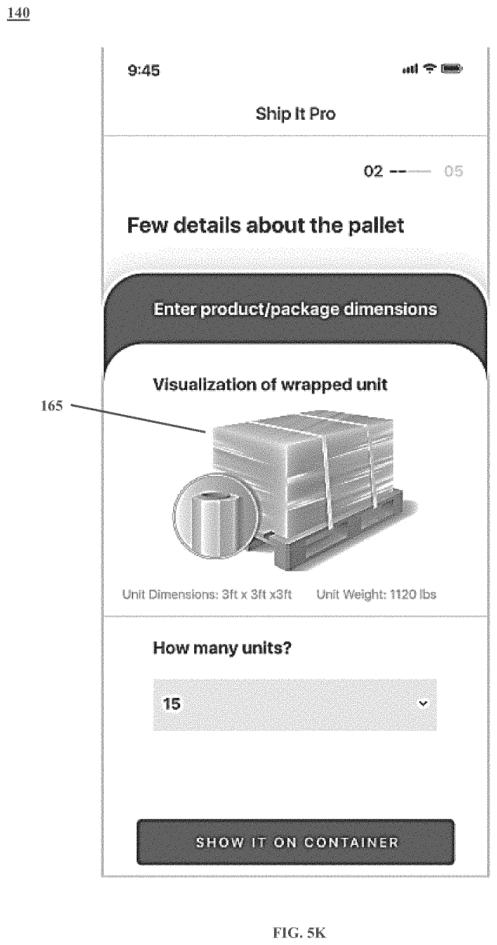

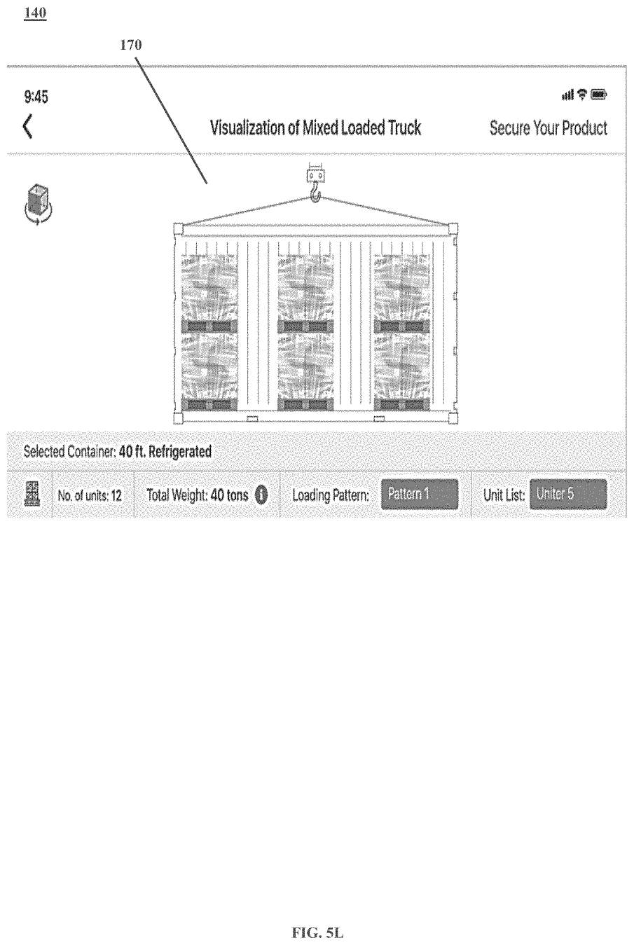

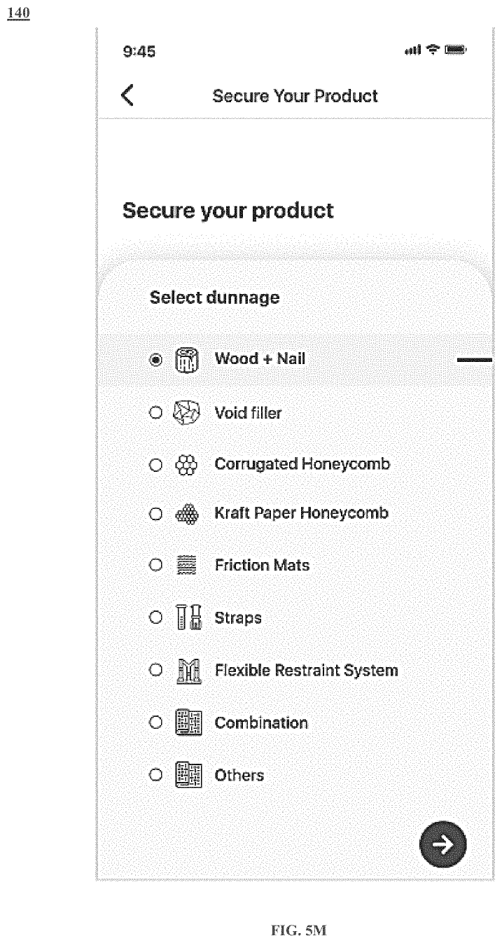

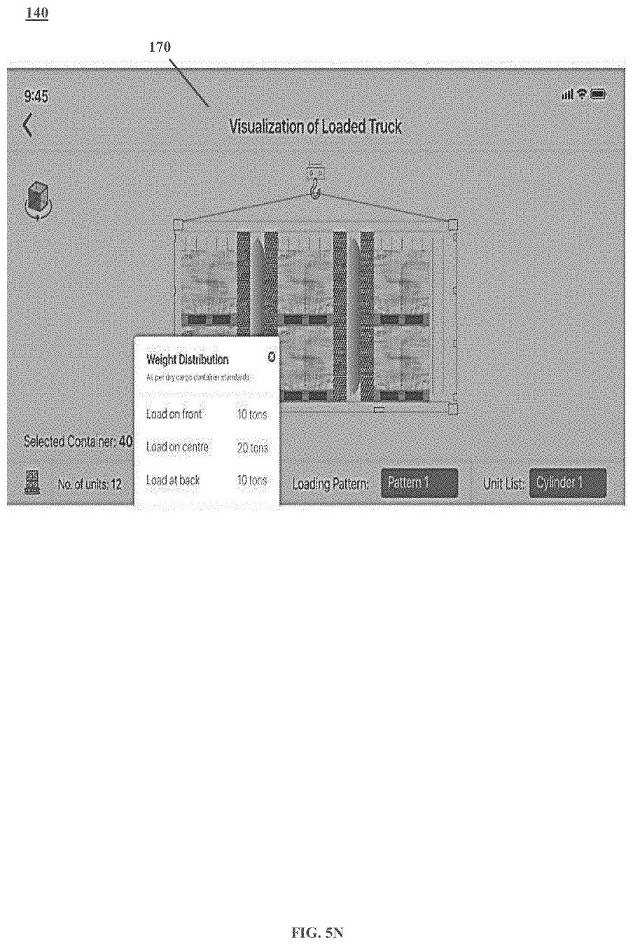

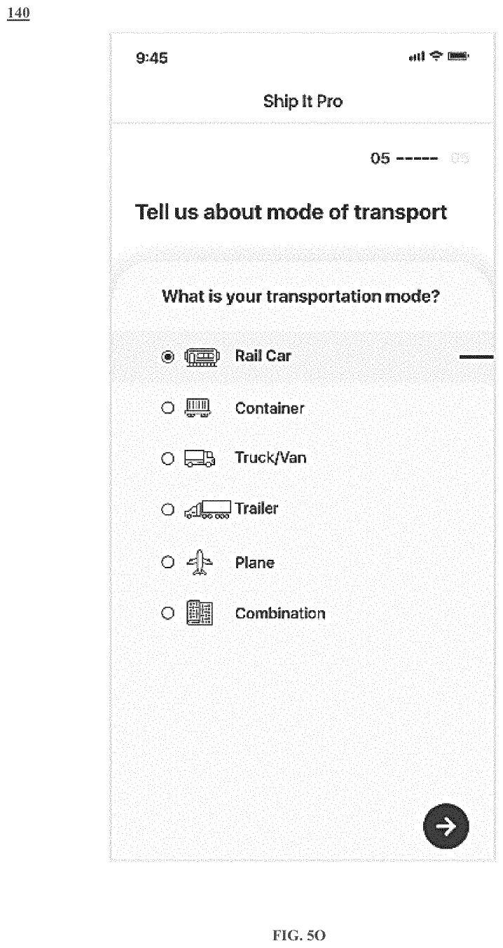

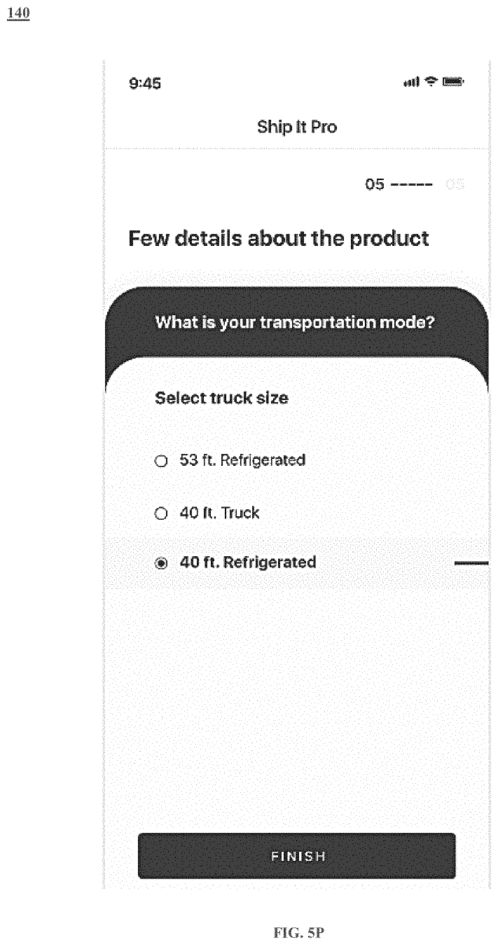

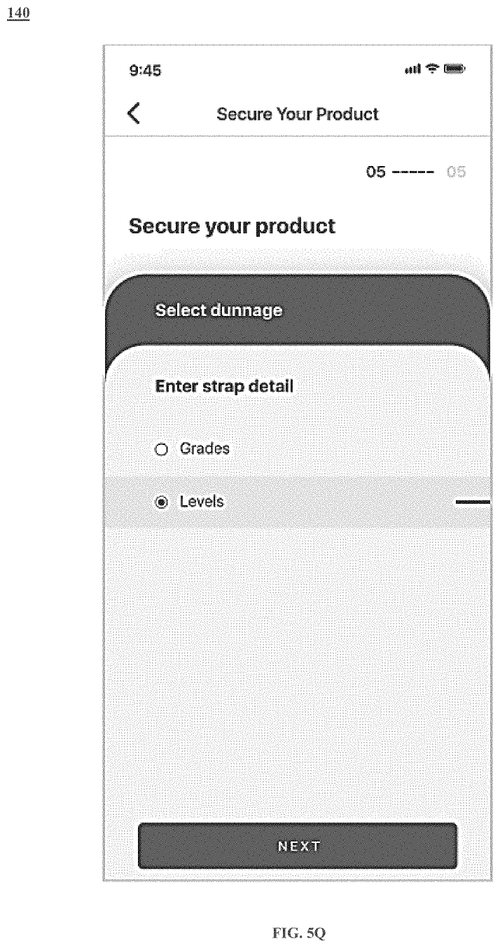

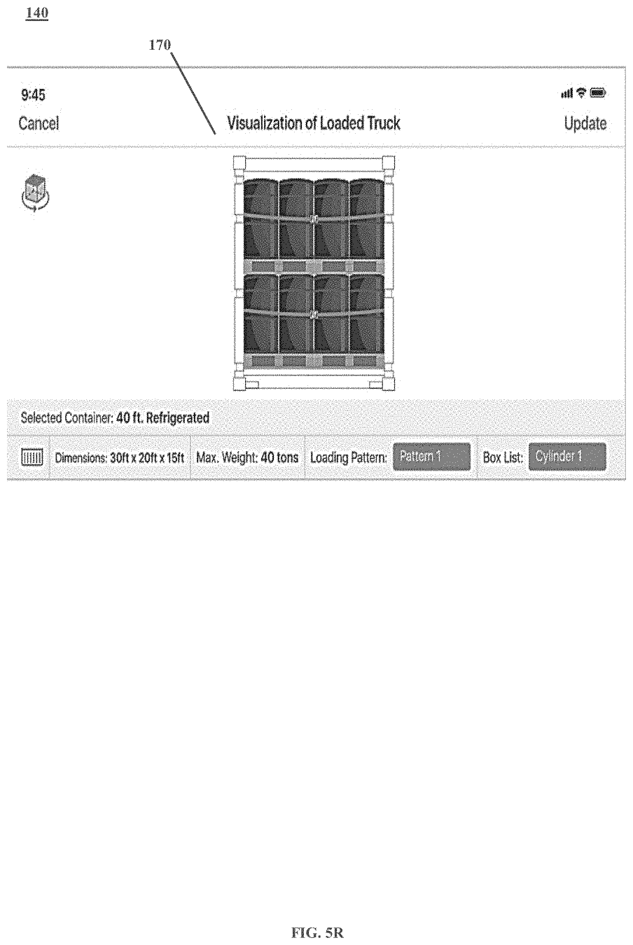

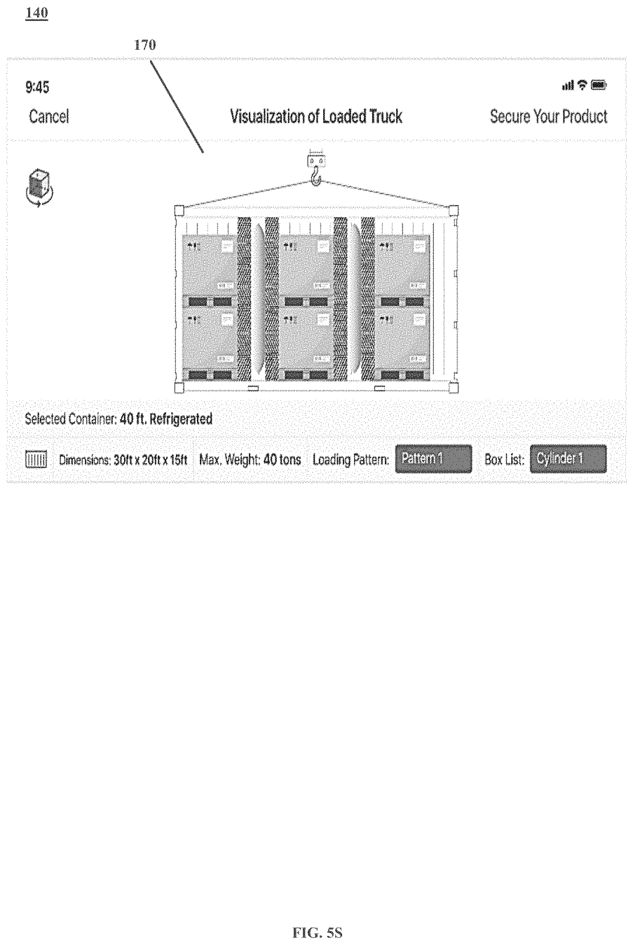

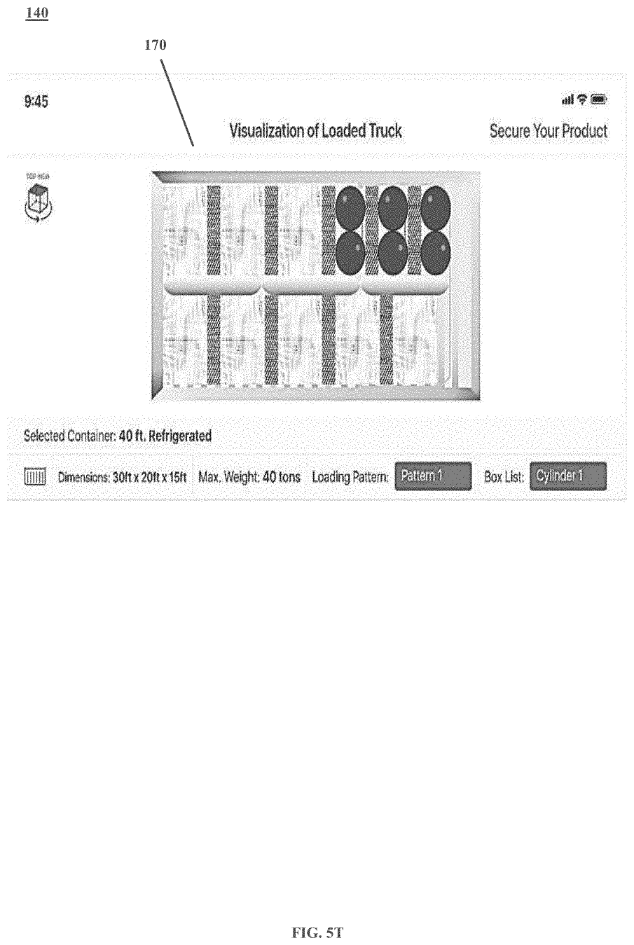

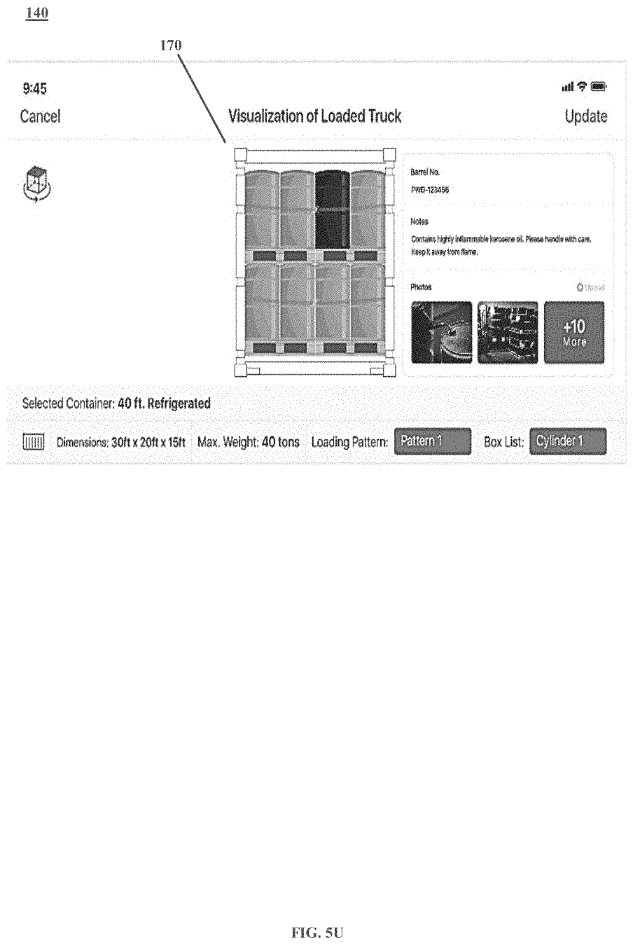

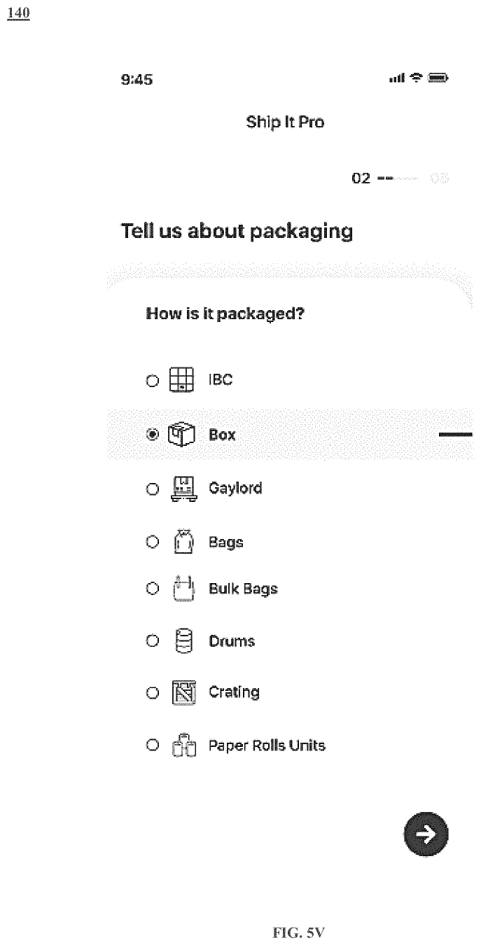

To aid understanding, this document is organized as follows. First, automatic vehicle load management is briefly introduced with reference to FIG. 1. Second, with reference to FIGS. 2-3, the discussion turns to exemplary embodiments that illustrate automatic vehicle load management system component designs. Specifically, automatic vehicle load management network and computing device implementations are disclosed. Then, with reference to FIG. 4, an illustrative process flow of an embodiment VLME (Vehicle Load Management Engine) is described. The exemplary disclosed VLME may be a management engine for managing data used in any suitable transportation application. Finally, with reference to FIGS. 5A-5V, illustrative screen capture views of an exemplary vehicle load management app are presented to explain improvements in vehicle load management technology.

FIG. 1 depicts an embodiment automated vehicle load management system in an exemplary operational scenario selecting shipping container transportation based on container parameters determined as a function of product specifications, determining a product configuration in the container based on the product and the transportation, and interactively visualizing a configured container load arrangement in a transport vehicle. The exemplary disclosed system may be a Transportation Damage Management System. For example, the exemplary disclosed system may be a system and method for transportation management and damage prevention. In FIG. 1, the user 105 employs the vehicle load management server 110 via a network component (e.g., a network cloud 115) to automatically select securement 120 approved by the transportation management system 125 to ship a product to the customer 130. In the illustrated example, the transportation management system 125 may be a mobile device. Transportation management system 125 may be any suitable user device for receiving input and/or providing output (e.g., raw data or other desired information) to a user. Transportation management system 125 may be, for example, a touchscreen device (e.g., a smartphone, a tablet, a smartboard, and/or any suitable computer device), a computer keyboard and monitor (e.g., desktop or laptop), an audio-based device for entering input and/or receiving output via sound, a tactile-based device for entering input and receiving output based on touch or feel, a dedicated user device or interface designed to work specifically with other components of the system, and/or any other suitable user device or interface. For example, transportation management system 125 may include a touchscreen device of a smartphone or handheld tablet. For example, transportation management system 125 may include a display that may include a graphical user interface to facilitate entry of input by a user and/or receiving output. For example, the exemplary disclosed system may provide notifications to a user via output transmitted to transportation management system 125. Transportation management system 125 may also be any suitable accessory such as a smart watch, Bluetooth headphones, and/or other suitable devices that may communicate with components of the exemplary disclosed system. Any of the exemplary disclosed devices described herein may be similar devices to transportation management system 125. In various scenarios, the securement 120 may include dunnage (e.g., any suitable securement measures), such as, for example, bubble wrap, loose packing material, blankets, plastic wrap, straps, pallets, padding, and other material useful to secure the product in a shipping carton, corrugated material (e.g., corrugated cardboard), or on a pallet. In the depicted example, the user 105 is a product shipper. In the illustrated example, the product shipper 105 uses a user device (e.g., a shipper mobile device 135) to operate the vehicle load management server 110. In the illustrated example, the shipper mobile device 135 is configured with any suitable application or program (e.g., a mobile app 140) adapted to facilitate automated vehicle load management via the vehicle load management server 110.

In the depicted embodiment, the product shipper 105 submits a vehicle load management request data (e.g., a load management request 145) to the vehicle load management server 110. In the illustrated example, the load management request 145 includes load parameters for a product to be shipped to the customer 130. In the depicted example, the load parameters included in the load management request 145 include product type, product quantity, product size, product weight, and/or packaging available to the product shipper 105, and dunnage available to the product shipper 105 (e.g., and/or any other exemplary data and/or parameters disclosed herein). In various embodiments, the load parameters included in the load management request 145 may be entered in the mobile app 140 (e.g., and/or any other suitable user device or interface for example as described herein) by the product shipper 105. In the depicted example, the vehicle load management server 110 receives the load management request 145 including the load parameters, and determines proposed load securement configuration 150 based on the load management request 145 and load management data accessible to the vehicle load management server 110 from the load management database 155. In the illustrated example, the load management data accessible from the load management database 155 includes dunnage configurations approved by the transportation management system 125 to protect the product during shipment to the customer 130. Load management database 125 may receive data transferred from any desired data source (e.g., including user input and/or third party data sources) including, for example, weather data, traffic pattern data, load diagram data, information covering sector risk and materials (e.g., dunnage materials) used in transportation and shipping, government and regulatory data, and any other desired data. For example, load management database 155 may receive and store data such as, for example, transportation mode data (e.g., road, rail, sea or air), product data, unit dimensions, pallet dimensions, load pattern data, data providing measurements of void spaces, transport type (e.g., trailer, container, or boxcar), product type data, unit weight data, pallet weight data, balance or scaled data, load securement type data, transport unit number data, product specification data, unitization product data, underhang or overhang data, center of gravity data, securement spec data, data defining condition of transport, packaging dimension data, pallet data, data describing number of units per load, data describing even weight distribution, securement placement data, origin and destination data, temperature data, data of GPS location services, destination report data, damage occurrence data, image data (e.g., photos and/or videos), notation data, mixed product load data, hazardous load data, data describing stacks (e.g., double stacked or triple stacked), California Bridge Law information and data, split load data, association of American Railroads Rules and Regulation information and data, and/or any other desired data. In the depicted embodiment, the transportation management system 125 is operated by a trucking company providing product transport by truck.

In the illustrated embodiment, the trucking company mobile device 125 also includes an instance of the mobile app 140 facilitating collaboration with the vehicle load management server 110. In various examples, the approved dunnage configurations may include industry standard dunnage configurations predetermined to protect a specific type of product in predefined transportation modes. In some embodiments, the vehicle load management server 110 may determine the proposed load securement configuration 150 based on container performance data and transport mode. The container performance data may be, for example, empirical data collected from container testing in various shipping modes. In an illustrative example, the transport mode may be truck, van, trailer, container, railroad (e.g., a railroad vehicle such as a boxcar), ship, or airplane (e.g., a cargo plane). For example, a particular container design may be selected to ship a predetermined product type in a railroad boxcar as a result of container performance test data indicating use of a container having that design resulted in a low product damage rate relative to container cost and dunnage cost for that product type and transport mode. In an illustrative example, the proposed load securement configuration 150 may be determined by the vehicle load management server 110 based on the packaging available to the product shipper 105, and the dunnage available to the product shipper 105. In an illustrative example, the load securement configuration determined by the vehicle load management server 110 may vary in the quantity, size, and type of container and dunnage, based on the product quantity, product type, or packaging available to the product shipper 105, and the dunnage available to the product shipper 105. For example, the vehicle load management server 110 may generate a load securement configuration having more or less containers, more or less dunnage, and more or less product per container, determined as a function of the product quantity, product type, packaging available to the product shipper 105, and the dunnage available to the product shipper 105. In the depicted embodiment, the transportation management system 125 (e.g., the transportation damage management system or TDMS) receives the proposed load securement configuration 150 and determines the proposed load securement configuration 150 satisfies predetermined trucking company standards to safely ship the product. Vehicle load management server 110 may include a vehicle load management module comprising computer-executable code stored in non-volatile memory and a processor. Also for example, the vehicle load management module and processor may be integrated into any suitable component or components of the exemplary disclosed system.

In the illustrated example, the vehicle load management server 110 receives from the transportation management system 125 an indication that the proposed load securement configuration 150 satisfies predetermined criteria (e.g., predetermined shipping criteria such as trucking or shipping company standards, government or regulatory standards, third party shipping or packaging criteria, and/or any other suitable criteria). The predetermined criteria may for example include a plurality of approved dunnage configurations that may include a plurality of shipping industry standard dunnage configurations that may be predetermined to protect a specific type of product or types of products. In the depicted example, upon receiving the indication that the proposed load securement configuration 150 satisfies the trucking company standard, the vehicle load management server 110 sends the approved load securement configuration 160 to the shipper mobile device 135 mobile app 140. In the depicted example, the vehicle load management server 110 and mobile app 140 provide the product shipper 105 visualizations in the mobile app 140 of the approved load securement configuration 165 and the container load arrangement 170 in the truck 175. In the depicted embodiment, the visualization of the container load arrangement 170 includes the illustrated warning advising caution handling one of the containers. In some embodiments, the user 105 may tap or click the warning in the mobile app 140 for more information. In various implementations, the load visualizations presented in the mobile app may interactively display the load distribution in the vehicle. In various examples, the user 105 may tap or click and drag in the mobile app 140 the container load arrangement 170 and load securement configuration 165 visualization elements to interactively reconfigure the load arrangement 170 or load securement 165 to adapt the load configuration and securement to the packaging, containers, and dunnage available, in accordance with regulations or standards. Some embodiment mobile app 140 and vehicle load management server 110 implementations may highlight in the mobile app 140 load arrangement or load securement configurations that are not compliant with regulations or standards (e.g., including highlighting non-compliant portions of configurations determined by vehicle load management server 110 and/or non-compliant portions of reconfigured configurations input or created by user 105). For example, non-compliant portions may be displayed on a display of the exemplary disclosed user device (e.g., device 135 or any other of the exemplary disclosed user devices operating with mobile app 140). In some examples, the mobile app 140 may send an updated load arrangement 170 or load securement configuration 165 to the vehicle load management server 110 to be validated by the vehicle load management server 110. Mobile app 140 may be accessed by one or more users via any suitable user device (e.g., mobile device 135, a user device of customer 130, a user device of a user of transportation management system 125, or any other desired user device).

In the illustrated example, the transportation management system 125 dispatches the truck 175 to ship the product to the customer 130. In the depicted example, the customer 130 receives the product undamaged. In the illustrated example, the customer 130 uses the customer mobile device 180 also configured with an instance of the mobile app 140 to indicate successful delivery to the vehicle load management server 110. In the depicted example, the customer 130 also uses the mobile app 140 to initiate damage claim 190 for the damaged product 195 that was shipped without adequate dunnage (e.g., and/or initiated claim of damage occurrences). Also for example, the product may have been damaged during transit, resulting in the initiation of a freight claim.

In at least some exemplary embodiments, the exemplary disclosed vehicle load management system may include a vehicle load management module, comprising computer-executable code stored in non-volatile memory, a processor, and a user device configured to communicate with the vehicle load management module and the processor. The vehicle load management module, the processor, and the user device may be configured to receive a vehicle load management request data for a product, identify one or more shipping container parameters of a shipping container based on the vehicle load management request data, select a transportation mode data identifying a transport vehicle based on the one or more shipping container parameters, and determine a securement configuration for the product in the shipping container based on the one or more shipping container parameters and the transportation mode data. The vehicle load management module, the processor, and the user device may be further configured to interactively visualize the securement configuration for the product in the shipping container in the transport vehicle. The one or more shipping container parameters may include at least one selected from the group of specifications of the product, a quantity of the product, a dunnage type, a container type, and combinations thereof. The vehicle load management module, the processor, and the user device may be further configured to determine whether or not an identified dunnage type and an identified container type are available. The vehicle load management module, the processor, and the user device may be further configured to determine a new securement configuration for the product in the shipping container based on an available dunnage and an available container type, which may be input via the user device to the vehicle load management module, when the identified dunnage type and the identified container type are not available. The vehicle load management module, the processor, and the user device may be configured to interactively visualize the securement configuration for the product in the shipping container in the transport vehicle when the identified dunnage type and the identified container type are available. The vehicle load management module, the processor, and the user device may be further configured to determine whether or not the securement configuration satisfies predetermined criteria. The predetermined criteria may include a plurality of shipping industry standard dunnage configurations predetermined to protect a product type included in the one or more shipping container parameters. The vehicle load management module, the processor, and the user device may be further configured to determine the securement configuration for the product in the shipping container based on a container performance data including empirical data based on container testing in a plurality of shipping modes. The transportation mode data may include information identifying at least one selected from the group of a truck, a railroad vehicle, a ship, an airplane and combinations thereof. The vehicle load management module, the processor, and the user device may be further configured to interactively visualize the securement configuration for the product in the shipping container in the transport vehicle and to receive input via the user device that interactively reconfigures the securement configuration into a new securement configuration. The vehicle load management module, the processor, and the user device may be further configured to highlight portions of the securement configuration or the new securement configuration that do not satisfy predetermined shipping criteria on a display of the user device.

In at least some exemplary embodiments, the exemplary disclosed method may include receiving a vehicle load management request data for a product from a user device, identifying one or more shipping container parameters of a shipping container based on the vehicle load management request data, selecting a transportation mode data identifying a transport vehicle based on the one or more shipping container parameters, determining a securement configuration for the product in the shipping container based on the one or more shipping container parameters and the transportation mode data, and interactively visualizing the securement configuration for the product in the shipping container in the transport vehicle using the user device. The exemplary disclosed method may also include receiving input via the user device that interactively reconfigures the securement configuration into a new securement configuration. The exemplary disclosed method may further include highlighting portions of the securement configuration or the new securement configuration that do not satisfy predetermined shipping criteria on a display of the user device. The exemplary disclosed method may also include determining whether or not the securement configuration corresponds to at least one of a plurality of shipping industry standard dunnage configurations predetermined to protect a product type included in the one or more shipping container parameters.

In at least some exemplary embodiments, the exemplary disclosed vehicle load management system may include a vehicle load management module, comprising computer-executable code stored in non-volatile memory, a processor, and a user device configured to communicate with the vehicle load management module and the processor. The vehicle load management module, the processor, and the user device may be configured to receive a vehicle load management request data for a product, identify one or more shipping container parameters of a shipping container based on the vehicle load management request data, the one or more shipping container parameters including at least one selected from the group of specifications of the product, a quantity of the product, a dunnage type, a container type, and combinations thereof, select a transportation mode data identifying a transport vehicle based on the one or more shipping container parameters, the transportation mode data including information identifying at least one selected from the group of a truck, a railroad vehicle, a ship, an airplane and combinations thereof, determine a securement configuration for the product in the shipping container based on the one or more shipping container parameters and the transportation mode data, and interactively visualize the securement configuration for the product in the shipping container in the transport vehicle. The vehicle load management module, the processor, and the user device may be further configured to determine whether or not an identified dunnage type and an identified container type are available. The vehicle load management module, the processor, and the user device may be further configured to determine a new securement configuration for the product in the shipping container based on an available dunnage and an available container type, which may be input via the user device to the vehicle load management module, when the identified dunnage type and the identified container type are not available. The vehicle load management module, the processor, and the user device may be configured to interactively visualize the securement configuration for the product in the shipping container in the transport vehicle when the identified dunnage type and the identified container type are available.

In at least some exemplary embodiments, the exemplary disclosed system, apparatus, and method may be used in any suitable application for transporting material. For example, the exemplary disclosed system, apparatus, and method may be used in any suitable shipping or transportation application.

In at least some exemplary embodiments, the exemplary disclosed system, apparatus, and method may provide an efficient and effective technique for transporting or shipping products or material. For example, the exemplary disclosed system, apparatus, and method may provide for an efficient and effective technique for configuring and reconfiguring products to be shipped, including an efficient and effective technique for optimizing shipping configurations for given dunnage, container types, and transportation modes.

In certain embodiments, the system may leverage a distributed ledger technology (DLT) to record and effect transactions between one or more shipper, transport operator, or customer, to validate the progress and timeline of transport and shipping. In certain embodiments, the DLT could be used to record executed transactions for the purposes of ensuring validity of such transactions, validating the chain of responsibility between shipper and customer, and confirming completion. In further embodiments, DLTs could be utilized and implemented to work in conjunction with smart contract principles, and allow for auto-execution of certain points associated with a transaction. For instance, smart contracts could be utilized to automatically track ongoing or recurring shipments and auto-execute certain terms upon breach of contract principles (for example, sending late notices and suspending recurring payment based on late scheduled transport services). One of ordinary skill in the art would appreciate that there are numerous types of smart contracts that could be utilized, based on the type and nature of the transaction being executed, and further would appreciate that there are numerous auto-executing terms that could be implemented, based on the type and nature of the transaction, and embodiments of the present invention are contemplated for use with any appropriate type of smart contract and auto-executing terms.

FIG. 2 depicts a schematic view of an embodiment automated vehicle load management network. In FIG. 2, according to an exemplary embodiment of the present disclosure, data may be transferred to the system, stored by the system and/or transferred by the system to users of the system across local area networks (LANs) or wide area networks (WANs). In accordance with various embodiments, the system may include numerous servers, data mining hardware, computing devices, or any combination thereof, communicatively connected across one or more LANs and/or WANs. One of ordinary skill in the art would appreciate that there are numerous manners in which the system could be configured, and embodiments of the present disclosure are contemplated for use with any configuration. Referring to FIG. 2, a schematic overview of a system in accordance with an embodiment of the present disclosure is shown. In the depicted embodiment, an exemplary system includes an embodiment vehicle load management server 110 configured to automatically determine approved load arrangement and securement configurations based on product specifications, load parameters, shipper and transport operator capability, capacity, and any other suitable criteria. In the illustrated embodiment, the vehicle load management server 110 is a computing device configured to facilitate automatic vehicle load management. In the depicted embodiment, the transportation management system 125 is a mobile device configured to facilitate transport operator load management decision support via the vehicle load management server 110. In the depicted example, the product shipper mobile device 135 is a smartphone configured with the mobile app 140, introduced with reference to FIG. 1, to provide a product shipper access to the vehicle load management server 110. In the illustrated embodiment, the customer mobile device 180 is a smartphone configured with the mobile app 140 for access to automatic vehicle load management services. In the depicted embodiment, the product shipper mobile device 135 is communicatively and operably coupled by the wireless access point 201 and the wireless link 202 with the network cloud 115 (for example, the Internet) to send, retrieve, or manipulate information in storage devices, servers, and network components, and exchange information with various other systems and devices via the network cloud 115. In the depicted example, the illustrative system includes the router 203 configured to communicatively and operably couple the vehicle load management server 110 to the network cloud 115 via the wireless access point 204 and the communication link 205. In the illustrated example, the load management database 155 is communicatively and operatively coupled with the vehicle load management server 110. In the illustrated example, the router 203 also communicatively and operably couples the transportation management system 125 to the network cloud 115 via the wireless access point 204 and the wireless communication link 206. In the depicted embodiment, the customer mobile device 180 is communicatively and operably coupled with the network cloud 115 by the wireless access point 207 and the wireless communication link 208. In various examples, one or more of: the product shipper mobile device 135, the vehicle load management server 110, the transportation management system 125, or the customer mobile device 180 may include an application server configured to store or provide access to information used by the system. In various embodiments, one or more application server may retrieve or manipulate information in storage devices and exchange information through the network cloud 115. In some examples, one or more of: the product shipper mobile device 135, the vehicle load management server 110, the transportation management system 125, or the customer mobile device 180 may include various applications implemented as processor-executable program instructions. In some embodiments, various processor-executable program instruction applications may also be used to manipulate information stored remotely and process and analyze data stored remotely across the network cloud 115 (for example, the Internet). According to an exemplary embodiment, as shown in FIG. 2, exchange of information through the network cloud 115 or other network may occur through one or more high speed connections. In some cases, high speed connections may be over-the-air (OTA), passed through networked systems, directly connected to one or more network cloud 115 or directed through one or more router. In various implementations, one or more router may be optional, and other embodiments in accordance with the present disclosure may or may not utilize one or more router. One of ordinary skill in the art would appreciate that there are numerous ways any or all of the depicted devices may connect with the network cloud 115 for the exchange of information, and embodiments of the present disclosure are contemplated for use with any method for connecting to networks for the purpose of exchanging information. Further, while this application may refer to high speed connections, embodiments of the present disclosure may be utilized with connections of any useful speed. In an illustrative example, components or modules of the system may connect to one or more of: the product shipper mobile device 135, the vehicle load management server 110, the transportation management system 125, or the customer mobile device 180 via the network cloud 115 or other network in numerous ways. For instance, a component or module may connect to the system i) through a computing device directly connected to the network cloud 115, ii) through a computing device connected to the network cloud 115 through a routing device, or iii) through a computing device connected to a wireless access point. One of ordinary skill in the art will appreciate that there are numerous ways that a component or module may connect to a device via network cloud 115 or other network, and embodiments of the present disclosure are contemplated for use with any network connection method. In various examples, one or more of: the product shipper mobile device 135, the vehicle load management server 110, the transportation management system 125, or the customer mobile device 180 could include a personal computing device, such as a smartphone, tablet computer, wearable computing device, cloud-based computing device, virtual computing device, or desktop computing device, configured to operate as a host for other computing devices to connect to. In some examples, one or more communications means of the system may be any circuitry or other means for communicating data over one or more networks or to one or more peripheral devices attached to the system, or to a system module or component. Appropriate communications means may include, but are not limited to, wireless connections, wired connections, cellular connections, data port connections, Bluetooth® connections, near field communications (NFC) connections, or any combination thereof. One of ordinary skill in the art will appreciate that there are numerous communications means that may be utilized with embodiments of the present disclosure, and embodiments of the present disclosure are contemplated for use with any communications means.

FIG. 3 depicts a structural view of an exemplary computing device adapted with an embodiment VLME (Vehicle Load Management Engine) configured to automate vehicle load management. In FIG. 3, the block diagram of the exemplary vehicle load management server 110 includes processor 305 and memory 310. The processor 305 is in electrical communication with the memory 310. The depicted memory 310 includes program memory 315 and data memory 320. The depicted program memory 315 includes processor-executable program instructions implementing the VLME (Vehicle Load Management Engine) 325. In some embodiments, the illustrated program memory 315 may include processor-executable program instructions configured to implement an OS (Operating System). In various embodiments, the OS may include processor executable program instructions configured to implement various operations when executed by the processor 305. In some embodiments, the OS may be omitted. In some embodiments, the illustrated program memory 315 may include processor-executable program instructions configured to implement various Application Software. In various embodiments, the Application Software may include processor executable program instructions configured to implement various operations when executed by the processor 305. In some embodiments, the Application Software may be omitted. In the depicted embodiment, the processor 305 is communicatively and operably coupled with the storage medium 330. In the depicted embodiment, the processor 305 is communicatively and operably coupled with the I/O (Input/Output) interface 335. In the depicted embodiment, the I/O interface 335 includes a network interface. In various implementations, the network interface may be a wireless network interface. In some designs, the network interface may be a Wi-Fi interface. In some embodiments, the network interface may be a Bluetooth interface. In an illustrative example, the vehicle load management server 110 may include more than one network interface. In some designs, the network interface may be a wireline interface. In some designs, the network interface may be omitted. In the depicted embodiment, the processor 305 is communicatively and operably coupled with the user interface 340. In various implementations, the user interface 340 may be adapted to receive input from a user or send output to a user. In some embodiments, the user interface 340 may be adapted to an input-only or output-only user interface mode. In various implementations, the user interface 340 may include an imaging display. In some embodiments, the user interface 340 may include an audio interface. In some designs, the audio interface may include an audio input. In various designs, the audio interface may include an audio output. In some implementations, the user interface 340 may be touch-sensitive. In some designs, the vehicle load management server 110 may include an accelerometer operably coupled with the processor 305. In various embodiments, the vehicle load management server 110 may include a GPS module operably coupled with the processor 305. In an illustrative example, the vehicle load management server 110 may include a magnetometer operably coupled with the processor 305. In some embodiments, the user interface 340 may include an input sensor array. In various implementations, the input sensor array may include one or more imaging sensor. In various designs, the input sensor array may include one or more audio transducer. In some implementations, the input sensor array may include a radio-frequency detector. In an illustrative example, the input sensor array may include an ultrasonic audio transducer. In some embodiments, the input sensor array may include image sensing subsystems or modules configurable by the processor 305 to be adapted to provide image input capability, image output capability, image sampling, spectral image analysis, correlation, autocorrelation, Fourier transforms, image buffering, image filtering operations including adjusting frequency response and attenuation characteristics of spatial domain and frequency domain filters, image recognition, pattern recognition, or anomaly detection. In various implementations, the depicted memory 310 may contain processor executable program instruction modules configurable by the processor 305 to be adapted to provide image input capability, image output capability, image sampling, spectral image analysis, correlation, autocorrelation, Fourier transforms, image buffering, image filtering operations including adjusting frequency response and attenuation characteristics of spatial domain and frequency domain filters, image recognition, pattern recognition, or anomaly detection. In some embodiments, the input sensor array may include audio sensing subsystems or modules configurable by the processor 305 to be adapted to provide audio input capability, audio output capability, audio sampling, spectral audio analysis, correlation, autocorrelation, Fourier transforms, audio buffering, audio filtering operations including adjusting frequency response and attenuation characteristics of temporal domain and frequency domain filters, audio pattern recognition, or anomaly detection. In various implementations, the depicted memory 310 may contain processor executable program instruction modules configurable by the processor 305 to be adapted to provide audio input capability, audio output capability, audio sampling, spectral audio analysis, correlation, autocorrelation, Fourier transforms, audio buffering, audio filtering operations including adjusting frequency response and attenuation characteristics of temporal domain and frequency domain filters, audio pattern recognition, or anomaly detection. In the depicted embodiment, the processor 305 is communicatively and operably coupled with the multimedia interface 345. In the illustrated embodiment, the multimedia interface 345 includes interfaces adapted to input and output of audio, video, and image data. In some embodiments, the multimedia interface 345 may include one or more still image camera or video camera. In various designs, the multimedia interface 345 may include one or more microphone. In some implementations, the multimedia interface 345 may include a wireless communication means configured to operably and communicatively couple the multimedia interface 345 with a multimedia data source or sink external to the vehicle load management server 110. In various designs, the multimedia interface 345 may include interfaces adapted to send, receive, or process encoded audio or video. In various embodiments, the multimedia interface 345 may include one or more video, image, or audio encoder. In various designs, the multimedia interface 345 may include one or more video, image, or audio decoder. In various implementations, the multimedia interface 345 may include interfaces adapted to send, receive, or process one or more multimedia stream. In various implementations, the multimedia interface 345 may include a GPU. In some embodiments, the multimedia interface 345 may be omitted. Useful examples of the illustrated vehicle load management server 110 include, but are not limited to, personal computers, servers, tablet PCs, smartphones, or other computing devices. In some embodiments, multiple vehicle load management server 110 devices may be operably linked to form a computer network in a manner as to distribute and share one or more resources, such as clustered computing devices and server banks/farms. Various examples of such general-purpose multi-unit computer networks suitable for embodiments of the disclosure, their typical configuration and many standardized communication links are well known to one skilled in the art, as explained in more detail in the foregoing FIG. 2 description. In some embodiments, an exemplary vehicle load management server 110 design may be realized in a distributed implementation. In an illustrative example, some vehicle load management server 110 designs may be partitioned between a client device, such as, for example, a phone, and, a more powerful server system, as depicted, for example, in FIG. 2. In various designs, a vehicle load management server 110 partition hosted on a PC or mobile device may choose to delegate some parts of computation, such as, for example, machine learning or deep learning, to a host server. In some embodiments, a client device partition may delegate computation-intensive tasks to a host server to take advantage of a more powerful processor, or to offload excess work. In an illustrative example, some devices may be configured with a mobile chip including an engine adapted to implement specialized processing, such as, for example, neural networks, machine learning, artificial intelligence, image recognition, audio processing, or digital signal processing. In some embodiments, such an engine adapted to specialized processing may have sufficient processing power to implement some features. However, in some embodiments, an exemplary vehicle load management server 110 may be configured to operate on a device with less processing power, such as, for example, various gaming consoles, which may not have sufficient processor power, or a suitable CPU architecture, to adequately support vehicle load management server 110. Various embodiment designs configured to operate on a such a device with reduced processor power may work in conjunction with a more powerful server system.

FIG. 4 depicts a process flow of an embodiment VLME (Vehicle Load Management Engine) in an illustrative automatic vehicle load management scenario. The method depicted in FIG. 4 is given from the perspective of the VLME 325 implemented via processor-executable program instructions executing on the vehicle load management server 110 processor 305, depicted in FIG. 3. In various embodiments, the method depicted in FIG. 4 may also be understood as from the perspective of the VLME 325 implemented via processor-executable program instructions executing on one or more processor configured in any or all of the product shipper mobile device 135, the transportation management system 125, or the customer mobile device 180, depicted at least in FIG. 1 and FIG. 2. In the illustrated embodiment, the VLME 325 executes as program instructions on the processor 305 configured in the VLME 325 host vehicle load management server 110, depicted in at least FIG. 1, FIG. 2, and FIG. 3. In some embodiments, the VLME 325 may execute as a cloud service communicatively and operatively coupled with system services, hardware resources, or software elements local to and/or external to the VLME 325 host vehicle load management server 110. The depicted method 400 begins at step 405 with the processor 305 receiving a load management request including load parameters such as, for example, product specifications, product quantity, available Dunnage, and available shipping containers. Processor 305 may receive data at any time during method 400. For example, data may be provided to load management database 155 from any user of the exemplary disclosed system, data sources such as described herein, and/or any other data source. In some embodiments, the load parameters included in the load management request may be entered in a mobile app by a product shipper. Then, the method continues at step 410 with the processor 305 determining container parameters based on the product specifications and product quantity specified in the received load parameters. Then, the method continues at step 415 with the processor 305 selecting a transportation mode based on the container parameters. In some examples, the selected transportation mode may be a proposed transportation mode determined based on product specifications and container parameters. Then, the method continues at step 420 with the processor 305 determining a load securement configuration based on the product specifications and the selected transportation mode. In some examples, the load securement configuration may include a Dunnage configuration determined by the method 400 to adequately protect the load based on the product type and transportation mode. Then, the method continues at step 425 with the processor 305 performing a test to determine if the Dunnage and containers identified in the load securement configuration determined at step 420 by the processor 425 are available. Upon a determination at step 425 by the processor 305 that the identified Dunnage and containers are available, the method continues at step 430 with the processor 305 providing an interactive visualization of a configured container load arrangement display presented in a visual transport vehicle model. In various embodiments, the configured container load arrangement visualized in the transport vehicle model may be displayed in a mobile app by the processor 305. Upon a determination at step 425 by the processor 305 the identified Dunnage and containers are not available, the method continues at step 435 with the processor 305 determining a new load securement configuration based on available Dunnage and containers. In at least some exemplary embodiments, the available Dunnage and containers may be input by a user to vehicle load management server 110 via a user device (e.g., mobile device 135). In an illustrative example, the load securement configuration determined by the method 400 may vary in the quantity, size, and type of container and dunnage, based on the product quantity, product type, or packaging available to a product shipper, and the dunnage available to the product shipper. For example, the method 400 may generate a load securement configuration having more or less containers, more or less dunnage, and more or less product per container, determined as a function of the product quantity, product type, packaging available to the product shipper, and the dunnage available to the product shipper.

The exemplary disclosed system and method may utilize artificial intelligence operations in performing any of the exemplary disclosed operation described herein. In at least some exemplary embodiments, the exemplary disclosed system may utilize sophisticated machine learning and/or artificial intelligence techniques to prepare and submit datasets and variables to cloud computing clusters and/or other analytical tools (e.g., predictive analytical tools) which may analyze such data using artificial intelligence neural networks. The exemplary disclosed system may for example include cloud computing clusters performing predictive analysis. For example, the exemplary neural network may include a plurality of input nodes that may be interconnected and/or networked with a plurality of additional and/or other processing nodes to determine a predicted result. Exemplary artificial intelligence processes may include filtering and processing datasets, processing to simplify datasets by statistically eliminating irrelevant, invariant or superfluous variables or creating new variables which are an amalgamation of a set of underlying variables, and/or processing for splitting datasets into train, test and validate datasets using at least a stratified sampling technique. The exemplary disclosed system may utilize prediction algorithms and approach that may include regression models, tree-based approaches, logistic regression, Bayesian methods, deep-learning and neural networks both as a stand-alone and on an ensemble basis, and final prediction may be based on the model/structure which delivers the highest degree of accuracy and stability as judged by implementation against the test and validate datasets.

The exemplary disclosed system and method may utilize artificial intelligence operations to standardize and/or enrich data received from the exemplary disclosed data sources using data stored in load management database 155. For example, the exemplary disclosed system and method may process image and video data received from the exemplary disclosed data sources. The exemplary disclosed system and method may process and/or compare image data that may be recorded using any suitable parameters or criteria (e.g., image data taken of some or an entire load content and securement configuration, specific points of damage to products, an entire product, and/or any other size or perspective of image data). The exemplary disclosed system and method may compare image data of a given load and/or securement configuration at various points of time such as at loading, during transport, unloading, and/or any other desired point of time. The exemplary disclosed system and method may store and process (e.g., ingest) metadata associated with image data and any other suitable type of data such as, for example, geographic location, time, and/or any other desired metadata.

The exemplary disclosed system and method may continuously update data stored in load management database 155 for example as described herein during method 400. The exemplary disclosed system and method may process (e.g., via artificial intelligence operations via vehicle load management server 110 and/or processor 305) the data stored in load management database 155 to continuously identify shipping container parameters that may be associated with data of reported damage. For example, the exemplary disclosed system and method may determine shipping container parameters and other data that may be associated with or that may cause damage to products during transport. For example, the exemplary disclosed system and method may determine that certain types of dunnage (e.g., and/or any other shipping container parameter) may be associated with damage to certain types of products during certain types of transport under certain conditions (e.g., weather and ambient conditions, turbulence, and/or any other condition data). By analyzing links and associations between damage to products, shipping container parameters, and/or any other data that may be stored in load management database 155, the exemplary disclosed system and method may determine causes of damage (e.g., how and why the damage occurred) to products during transportation and determine or propose securement configurations (e.g., load patterns) that may prevent the type of damage that was identified. The exemplary disclosed system and method may thereby continuously improve securement configurations (e.g., load patterns) during an operation of method 400. The data of the improved securement configurations may be accessed and utilized by users based on improved load diagrams being provided to users via the exemplary disclosed user devices. Also for example, the exemplary disclosed reconfigured securement configurations provided by users based on reconfiguring securement configurations may be recorded and processed by the exemplary disclosed system and method and used to provide improved securement configurations to users. The exemplary disclosed system and method may thereby provide failure identification and enhanced securement configurations to users to prevent future damage to transported products and materials. For example, data and improvements may be communicated between the shipper, carrier and the receiver. For example, the same securement configuration (e.g., diagram) may be sent to some or all parties (e.g., allowing interaction with the same diagram by the carrier and receiver, for example by being sent to the carrier and the receiver). For example, the carrier may make modifications to the exemplary disclosed diagram. The receiver may use the same diagram as a report at a destination (e.g., to send the feedback of a damaged product back to shipper). For example, damage may be reported, including where and at what unit in a load the damage occurred. Also for example, when the exemplary disclosed diagram is sent from a shipper to a carrier, GPS location services may be available.

FIGS. 5A-5V together depict illustrative screen capture views of an embodiment mobile app configured to facilitate automatic vehicle load management. FIGS. 5A-5V together disclose illustrative screen capture views of the embodiment automatic vehicle load management mobile app 140, introduced in FIG. 1, facilitating exemplary automatic vehicle load management operational scenarios in collaboration with an embodiment vehicle load management server.

Although various embodiments have been described with reference to the Figures, other embodiments are possible. For example, some embodiments may advantageously equip multiple levels of an organization's supply chain with an easy to use tool to plan loads, secure loads, maximize loads, budget for loads, reduce claims, increase compliance, create consistency, train and review employees, create standards, customize based on change in packing types and sizes, increase accountability, and present new methods for testing and approval.

Some embodiment designs may include software or application implementations permitting a user to design their load patterns of products in all modes of transportation. Various embodiments may allow a user to identify damage occurrences at origin and destination. In an illustrative example, some designs may enable a user to apply appropriate Dunnage materials (void fill, airbags, strapping, friction mats, and the like) to properly secure the loads as they see fit, or in accordance with the governing body guidelines of that mode of transportation and best practices. Some embodiment software or application implementations may also aid in even distribution of weight of product in a transportation mode, in addition to enhancing tracking, securement, and reporting. Various embodiment software or application designs may include visualization employing photos, container, load, transport, and securement element notation identifying elements and providing detailed element information, multiple languages, and multiple units of measure.

In a non-limiting illustrative example, various embodiment automated vehicle load management software or application implementations may accumulate load management data aiding at least the following supply chain areas:

Budgeting of Dunnage materials

Reduction in claims

Damage Identification

Standardization of load patterns

Identification of problem transportation lanes

Accountability of shipper, carrier and end user

Proper weight distribution

Maximization of load space

Tracking

Purchasing

Reduce carbon foot print

Reduce lost time

Lost product

Derailments

Traffic accidents/Congestion

Packaging Product Line Simplification

New Product Blueprinting

Reduce Waste

Reduce time at weigh stations

Reduce inspections

Reduce re runs for manufacturing: line switch, short runs, and the like

In an illustrative non-limiting example, some embodiment automated vehicle load management software or application implementations may benefit at least the following departments of a transportation management organization:
Operations
Purchasing
Logistics
Transportation
Shipping
Warehousing
Claims
Manufacturing
Sales
Safety/Compliance

In at least some exemplary embodiments, the exemplary disclosed system, apparatus, and method may relate to selecting shipping container transportation based on container parameters determined as a function of product specifications, determining a product configuration in the container based on the product and the transportation, and interactively visualizing a configured container load arrangement in a transport vehicle. In an illustrative example, the shipping container may be a railroad boxcar. The container parameters may include, for example, size and strength (e.g., based on structural configuration, material strength, and/or any other suitable criteria). The container parameters may provide for container configuration adapted to the load. In some embodiments, the product configuration in the container may include a dunnage configuration selected based on container performance data and transport mode. Some embodiments may select load securement configurations approved by transport vehicle operators and regulations to adequately protect the load during shipping. Various examples may advantageously provide visualization of the container load arrangement in a transport vehicle, permitting a product shipper to interactively select a suitable dunnage configuration to protect the load.

In at least some exemplary embodiments, the exemplary disclosed automated vehicle load management process may include selecting shipping container transportation based on container parameters determined as a function of product specifications, determining a product configuration in the container based on the product and the transportation, and interactively visualizing a configured container load arrangement in a transport vehicle.

In at least some exemplary embodiments, the exemplary disclosed automated vehicle load management apparatus may include a processor, a memory that is not a transitory propagating signal, the memory operably and communicatively coupled with the processor and encoding computer readable instructions, including processor executable program instructions, the computer readable instructions accessible to the processor. The processor executable program instructions, when executed by the processor, may cause the processor to perform operations comprising select shipping container transportation based on container parameters determined as a function of product specifications, determine a product configuration in the container based on the product and the transportation, and interactively visualize a configured container load arrangement in a transport vehicle.

In the Summary above and in this Detailed Description, and the Claims below, and in the accompanying drawings, reference is made to particular features of various embodiments of the invention. It is to be understood that the disclosure of embodiments of the invention in this specification includes all possible combinations of such particular features. For example, where a particular feature is disclosed in the context of a particular aspect or embodiment of the invention, or a particular claim, that feature can also be used—to the extent possible—in combination with and/or in the context of other particular aspects and embodiments of the invention, and in the invention generally.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

In the present disclosure, various features may be described as being optional, for example, through the use of the verb “may;”, or, through the use of any of the phrases: “in some embodiments,” “in some implementations,” “in some designs,” “in various embodiments,” “in various implementations,”, “in various designs,” “in an illustrative example,” or “for example;” or, through the use of parentheses. For the sake of brevity and legibility, the present disclosure does not explicitly recite each and every permutation that may be obtained by choosing from the set of optional features. However, the present disclosure is to be interpreted as explicitly disclosing all such permutations. For example, a system described as having three optional features may be embodied in seven different ways, namely with just one of the three possible features, with any two of the three possible features or with all three of the three possible features.

In various embodiments, elements described herein as coupled or connected may have an effectual relationship realizable by a direct connection or indirectly with one or more other intervening elements.

In the present disclosure, the term “any” may be understood as designating any number of the respective elements, i.e. as designating one, at least one, at least two, each or all of the respective elements. Similarly, the term “any” may be understood as designating any collection(s) of the respective elements, i.e. as designating one or more collections of the respective elements, a collection comprising one, at least one, at least two, each or all of the respective elements. The respective collections need not comprise the same number of elements.

While various embodiments of the present invention have been disclosed and described in detail herein, it will be apparent to those skilled in the art that various changes may be made to the configuration, operation and form of the invention without departing from the spirit and scope thereof. In particular, it is noted that the respective features of embodiments of the invention, even those disclosed solely in combination with other features of embodiments of the invention, may be combined in any configuration excepting those readily apparent to the person skilled in the art as nonsensical. Likewise, use of the singular and plural is solely for the sake of illustration and is not to be interpreted as limiting.

The Abstract is provided to comply with 37 C. F. R. § 1.72(b), to allow the reader to quickly ascertain the nature of the technical disclosure and is submitted with the understanding that it will not be used to interpret or limit the scope or meaning of the claims.

In the present disclosure, all embodiments where “comprising” is used may have as alternatives “consisting essentially of,” or “consisting of.” In the present disclosure, any method or apparatus embodiment may be devoid of one or more process steps or components. In the present disclosure, embodiments employing negative limitations are expressly disclosed and considered a part of this disclosure.

Certain terminology and derivations thereof may be used in the present disclosure for convenience in reference only and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

The term “comprises” and grammatical equivalents thereof are used herein to mean that other components, ingredients, steps, among others, are optionally present. For example, an embodiment “comprising” (or “which comprises”) components A, B and C can consist of (i.e., contain only) components A, B and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose limit is the second number. For example, 25 to 100 mm means a range whose lower limit is 25 mm and upper limit is 100 mm.

Any element in a claim herein that does not explicitly state “means for” performing a specified function, or “step for” performing a specific function, is not to be interpreted as a “means” or “step” clause as specified in 35 U.S.C. § 112 (f). Specifically, any use of “step of” in the claims herein is not intended to invoke the provisions of 35 U.S.C. § 112 (f). Elements recited in means-plus-function format are intended to be construed in accordance with 35 U.S.C. § 112 (f).

Recitation in a claim of the term “first” with respect to a feature or element does not necessarily imply the existence of a second or additional such feature or element.

The phrases “connected to,” “coupled to” and “in communication with” refer to any form of interaction between two or more entities, including mechanical, electrical, magnetic, electromagnetic, fluid, and thermal interaction. Two components may be functionally coupled to each other even though they are not in direct contact with each other. The term “abutting” refers to items that are in direct physical contact with each other, although the items may not necessarily be attached together.

The word “exemplary” is used herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

Reference throughout this specification to “an embodiment” or “the embodiment” means that a particular feature, structure or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, Figure, or description thereof for the purpose of streamlining the disclosure. This method of disclosure, however, is not to be interpreted as reflecting an intention that any claim in this or any application claiming priority to this application require more features than those expressly recited in that claim. Rather, as the following claims reflect, inventive aspects may lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

According to an embodiment of the present invention, the system and method may be accomplished through the use of one or more computing devices. As depicted, for example, at least in FIG. 1, FIG. 2, and FIG. 3, one of ordinary skill in the art would appreciate that an exemplary system appropriate for use with embodiments in accordance with the present application may generally include one or more of a Central processing Unit (CPU), Random Access Memory (RAM), a storage medium (e.g., hard disk drive, solid state drive, flash memory, cloud storage), an operating system (OS), one or more application software, a display element, one or more communications means, or one or more input/output devices/means. Examples of computing devices usable with embodiments of the present invention include, but are not limited to, proprietary computing devices, personal computers, mobile computing devices, tablet PCs, mini-PCs, servers or any combination thereof. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In various embodiments, communications means, data store(s), processor(s), or memory may interact with other components on the computing device, in order to effect the provisioning and display of various functionalities associated with the system and method detailed herein. One of ordinary skill in the art would appreciate that there are numerous configurations that could be utilized with embodiments of the present invention, and embodiments of the present invention are contemplated for use with any appropriate configuration.

According to an embodiment of the present invention, the communications means of the system may be, for instance, any means for communicating data over one or more networks or to one or more peripheral devices attached to the system. Appropriate communications means may include, but are not limited to, circuitry and control systems for providing wireless connections, wired connections, cellular connections, data port connections, Bluetooth connections, or any combination thereof. One of ordinary skill in the art would appreciate that there are numerous communications means that may be utilized with embodiments of the present invention, and embodiments of the present invention are contemplated for use with any communications means.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description may set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a sequence of computational instructions or program instructions. It will be appreciated that a programmable apparatus (i.e., computing device) can receive such a computer program and, by processing the computational instructions thereof, produce a further technical effect.

A programmable apparatus may include one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. A vehicle load management system, comprising:
a vehicle load management module, comprising computer-executable code stored in non-volatile memory;
a processor; and
a user device configured to communicate with the vehicle load management module and the processor;
wherein the vehicle load management module, the processor, and the user device are configured to:
receive a vehicle load management request data for a product;
identify one or more shipping container parameters of a shipping container based on the vehicle load management request data;
select a transportation mode data identifying a transport vehicle based on the one or more shipping container parameters; and
determine a securement configuration for the product in the shipping container based on the one or more shipping container parameters and the transportation mode data.

2. The vehicle load management system of claim 1, wherein the vehicle load management module, the processor, and the user device are further configured to interactively visualize the securement configuration for the product in the shipping container in the transport vehicle.

3. The vehicle load management system of claim 1, wherein the one or more shipping container parameters includes at least one selected from the group of specifications of the product, a quantity of the product, a dunnage type, a container type, and combinations thereof.

4. The vehicle load management system of claim 3, wherein the vehicle load management module, the processor, and the user device are further configured to determine whether or not an identified dunnage type and an identified container type are available.

5. The vehicle load management system of claim 4, wherein the vehicle load management module, the processor, and the user device are further configured to determine a new securement configuration for the product in the shipping container based on an available dunnage and an available container type, which are input via the user device to the vehicle load management module, when the identified dunnage type and the identified container type are not available.

6. The vehicle load management system of claim 4, wherein the vehicle load management module, the processor, and the user device are configured to interactively visualize the securement configuration for the product in the shipping container in the transport vehicle when the identified dunnage type and the identified container type are available.

7. The vehicle load management system of claim 1, wherein the vehicle load management module, the processor, and the user device are further configured to determine whether or not the securement configuration satisfies predetermined criteria.

8. The vehicle load management system of claim 7, wherein the predetermined criteria includes a plurality of shipping industry standard dunnage configurations predetermined to protect a product type included in the one or more shipping container parameters.

9. The vehicle load management system of claim 1, wherein the vehicle load management module, the processor, and the user device are further configured to determine the securement configuration for the product in the shipping container based on a container performance data including empirical data based on container testing in a plurality of shipping modes.

10. The vehicle load management system of claim 1, wherein the transportation mode data includes information identifying at least one selected from the group of a truck, a railroad vehicle, a ship, an airplane and combinations thereof.

11. The vehicle load management system of claim 1, wherein the vehicle load management module, the processor, and the user device are further configured to interactively visualize the securement configuration for the product in the shipping container in the transport vehicle and to receive input via the user device that interactively reconfigures the securement configuration into a new securement configuration.

12. The vehicle load management system of claim 11, wherein the vehicle load management module, the processor, and the user device are further configured to highlight portions of the securement configuration or the new securement configuration that do not satisfy predetermined shipping criteria on a display of the user device.

13. A method, comprising:
receiving a vehicle load management request data for a product from a user device;
identifying one or more shipping container parameters of a shipping container based on the vehicle load management request data;
selecting a transportation mode data identifying a transport vehicle based on the one or more shipping container parameters;
determining a securement configuration for the product in the shipping container based on the one or more shipping container parameters and the transportation mode data; and
interactively visualizing the securement configuration for the product in the shipping container in the transport vehicle using the user device.

14. The method of claim 13, further comprising receiving input via the user device that interactively reconfigures the securement configuration into a new securement configuration.

15. The method of claim 14, further comprising highlighting portions of the securement configuration or the new securement configuration that do not satisfy predetermined shipping criteria on a display of the user device.

16. The method of claim 13, further comprising determining whether or not the securement configuration corresponds to at least one of a plurality of shipping industry standard dunnage configurations predetermined to protect a product type included in the one or more shipping container parameters.

17. A vehicle load management system, comprising:
a vehicle load management module, comprising computer-executable code stored in non-volatile memory;
a processor; and
a user device configured to communicate with the vehicle load management module and the processor;
wherein the vehicle load management module, the processor, and the user device are configured to:
receive a vehicle load management request data for a product;
identify one or more shipping container parameters of a shipping container based on the vehicle load management request data, the one or more shipping container parameters including at least one selected from the group of specifications of the product, a quantity of the product, a dunnage type, a container type, and combinations thereof;
select a transportation mode data identifying a transport vehicle based on the one or more shipping container parameters, the transportation mode data including information identifying at least one selected from the group of a truck, a railroad vehicle, a ship, an airplane and combinations thereof;
determine a securement configuration for the product in the shipping container based on the one or more shipping container parameters and the transportation mode data; and
interactively visualize the securement configuration for the product in the shipping container in the transport vehicle.

18. The vehicle load management system of claim 17, wherein the vehicle load management module, the processor, and the user device are further configured to determine whether or not an identified dunnage type and an identified container type are available.

19. The vehicle load management system of claim 18, wherein the vehicle load management module, the processor, and the user device are further configured to determine a new securement configuration for the product in the shipping container based on an available dunnage and an available container type, which are input via the user device to the vehicle load management module, when the identified dunnage type and the identified container type are not available.

20. The vehicle load management system of claim 18, wherein the vehicle load management module, the processor, and the user device are configured to interactively visualize the securement configuration for the product in the shipping container in the transport vehicle when the identified dunnage type and the identified container type are available.
